(19) United States
(12) Patent Application Publication
(10) Pub. No.: US 2026/0017642 A1
(43) Pub. Date: Jan. 15, 2026

(54) CREDENTIAL WITH FLEXIBLE FUNDING

(71) Applicant: Wells Fargo Bank, N.A., San Francisco, CA (US)

(72) Inventors: William Howard Bondar, Avon Lake, OH (US); Allison Randolph King, Baltimore, MD (US); Young M. Yang, San Francisco, CA (US)

(21) Appl. No.: 18/768,898

(22) Filed: Jul. 10, 2024

(51) Int. Cl. G06Q 20/38

(52) U.S. Cl. CPC G06Q 20/3821

(57) ABSTRACT

Various systems and methods for managing a flexible payment credential are described herein. A system for processing a transaction for a flexible credential is configured to receive, from a payment network, an indication of a payment transaction involving an accountholder of the flexible credential; evaluate rules established by the accountholder to determine a funding source to use in the payment transaction; access a prepaid account as a default funding source when there are no rules established by the accountholder to determine the funding source; and complete the payment transaction using the prepaid account as the funding source.

### BACKGROUND

In the context of credit cards, debit cards, charge cards, and similar payment instruments, a credential refers to the information and data used to authenticate the identity of the cardholder and authorize transactions. A credential may also be used to describe a physical object used to store sensitive information, such as an account number, a cardholder name, a card verification value or code, a personal identification number, security measures, or the like. Credentials are essential for ensuring the security and validity of financial transactions.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a diagram illustrating an operating environment, according to an embodiment;

FIG. 2 is a flow diagram illustrating a process for evaluating rules, according to an embodiment;

FIG. 3 is a flow diagram illustrating a process for reloading a prepaid card, according to an embodiment;

FIG. 4 is an example user interface of an application used to configure rules, according to an embodiment;

FIG. 5 is a flowchart illustrating a method for processing a transaction for a flexible credential, according to an embodiment; and

FIG. 6 is a block diagram illustrating an example machine upon which any one or more of the techniques (e.g., methodologies) discussed herein may perform, according to an example embodiment.

### DETAILED DESCRIPTION

In the following description, for purposes of explanation, numerous specific details are set forth in order to provide a thorough understanding of some example embodiments. It will be evident, however, to one skilled in the art that the present disclosure may be practiced without these specific details.

Systems and methods described herein provide a payment card (also referred to as a payment credential, or credential) that is able to access (or be funded by) several different financial accounts. This type of flexible, configurable credential reduces the number of physical credentials a person has to carry while maintaining backwards compatibility with an infrastructure built around card readers and other devices that read a payment credential at point the sale (POS).

The present systems and methods described here add a new and useful physical credential for consumers. A flexible credential may be configured using an application (e.g., an app on a mobile device) to draw from several accounts. These accounts may be a credit line, a savings account, a brokerage account, a loyalty points account, a designated prepaid fund, or the like. The financial accounts may all be under one financial institution or may span several institutions. Additionally, and optionally, flexible credential may be siloed in a single payment network or may be payment network agnostic. Using an application, the user/consumer may configure the flexible credential to draw from a desired account based on various rules. A default funding source may be used when rules are not established or when no rules apply to a given situation. These functions and others are described in more detail below.

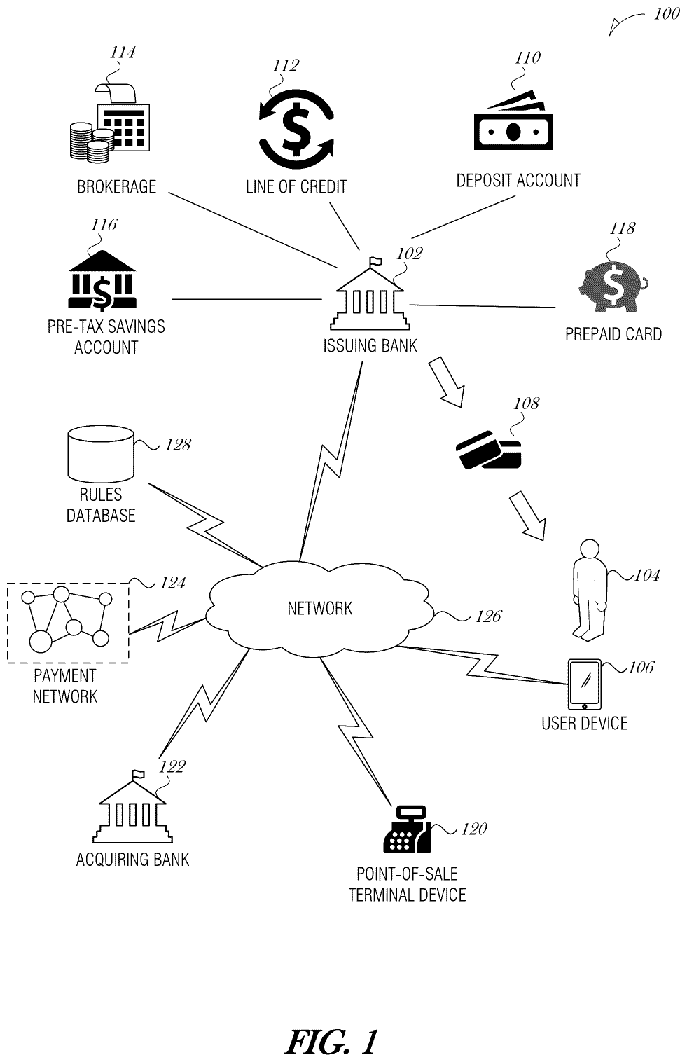

FIG. 1 is a diagram illustrating an operating environment 100, according to an embodiment. Payment credentials are managed using three primary entities: a credential issuer, a credential holder, and a credential verifier. In the case of a payment credential, the credential issuer is typically a financial institution (e.g., a bank, credit union, credit card company, etc.), the credential holder is the person authorized to use the payment credential, and the verifier may be a business, service, or other person or entity that wants to validate the user's payment credential at a point-of-sale (POS). The POS may be an online store, a restaurant, a grocery checkout lane, a dentist office, or the like.

The credential holder typically provides permission to use a POS terminal device to read some or all of the data contained in the payment credential, which may include the person's name, account number, personal identification number, digital signature, card verification value (CVV) or card verification code (CVC), and the like.

For example, during a transaction where the card is physically presented (i.e., a card-present transaction), where customers physically swipe, insert, or tap a card at a point-of-sale (POS) terminal, the POS terminal may read data from the credential and transmit it to an acquiring bank associated with the merchant to settle the transaction. In an online or phone-based transaction (i.e., card-not-present transaction), the information may be provided electronically or verbally by the customer, and then later electronically transmitted to the acquiring bank. For instance, the customer may fill out a billing details form in a webpage to provide the card holder name, card number, CVV/CVC, billing address, and the like. This information may be sent via an application programming interface (API) to the acquiring bank. As another example, the customer may provide this information to an operator during a phone call. Other types of card-not-present transactions may be implemented through other communication channels (e.g., mail, text, written and sent through post mail, etc.).

During a card-present transaction, the POS terminal uses a POS provider system (e.g., Square, Toast, etc.) to connect to a payment network (e.g., Visa, Mastercard, Amex, Discover, Zelle, etc.), which communicates with the purchaser's bank (referred to as the issuer bank) to move money to the merchant's bank (referred to as the acquiring bank). In a card-not-present transaction, a backend system or a person enters the information via an application programming interface (API) or by other mechanisms to get the information into an electronic payment network.

In the environment illustrated in FIG. 1, an issuing bank 102 issues a payment credential 108 to a user 104. The payment credential 108 may be disposed in a standardized credit card form and include information printed or stamped on the substrate. The information may include the card holder's name, a credit card number, an expiration date, an indication of the issuing bank, an indication of the compatible payment network (e.g., Visa, Mastercard, Discover, Amex, etc.), and the like. The payment credential 108 may include a magnetic stripe (magstripe) encoded with some or all of the information that is available on the substrate. Additionally, the payment credential 108 may include an EMV chip, used to provide more secure payments. Additionally, the payment credential 108 may optionally include a radio frequency identification (RFID) chip, used in contactless payments.

In addition to the physical payment credential 108, the user 104 is able to download or otherwise obtain an application provided by the issuing bank 102. The application may be installed on a user device. The user device 106 may be of any type of mobile device including, but not limited to a smartphone, a laptop computer, a tablet device, a personal digital assistant, a wearable device (e.g., a smartwatch), or the like. The user 104 may use the application to configure the use of the payment credential 108.

One way that the user 104 can configure the payment credential 108 is to use a specific funding source for a payment based on one or more rules. The rules may be defined using the issuing bank's application on the user device 106 and stored in a rules database 128. The rules may be used to define that some transactions are processed to draw from a checking account and other transactions are processed to draw from a credit line. The rules may be based on the amount of the transaction, the type of merchant (e.g., the merchant category code (MCC) established by the International Organization for Standardization (ISO)), the day or time of the transaction, or other factors.

Returning to FIG. 1, the issuing bank 102 may provide multiple sources to the user 104 to settle the transaction. The sources include, but are not limited to a deposit account 110, line of credit 112, brokerage account 114, pre-tax savings account 116, prepaid card 118, or the like. The deposit account 110 may be a checking, savings, money market, or other account that the user 104 holds at the issuing bank 102 where the user 104 is able to deposit and withdraw money. The line of credit 112 may be a credit card, home equity line of credit (HELOC), personal loan, or other type of credit provided to the user 104 by the issuing bank 102. The brokerage account 114 may be a holding account for uninvested funds. The pre-tax savings account 116 may include health savings accounts (HSA), flexible spending accounts (FSA), heath reimbursement arrangement accounts (HRA), or the like.

A prepaid card 118 is also referred to as a reloadable debit card. A user 104 may use a prepaid card 118 in much the same was as a standard credit card or debit card. The key difference is that the prepaid card 118 is not linked to a line of credit 112. Instead, a prepaid card 118 is loaded (e.g., funded) with some amount of money. The prepaid card 118 may have a maximum value (e.g., a maximum amount that can be loaded on the prepaid card 118). As the user 104 purchases things or services and uses the prepaid card 118, the balance is reduced to reflect these purchases. The user 104 may reload the prepaid card 118 by funding it, for example, from a deposit account 110.

When the user 104 transacts in a purchase, the user 104 presents the payment credential 108 to a POS terminal device 120 (in a card-present transaction) or provides information about the payment credential 108 to have it entered (in a card-not-present transaction). The POS terminal device 120 transmits information to the acquiring bank 122 (the merchant's bank). Then a payment network 124 (e.g., Visa) acts as an intermediary, routing the transaction information to the issuing bank 102 for approval or denial, and then handling the transfer of funds from the issuing bank 102 to the acquiring bank 122.

When the issuing bank 102 receives a request to approve the transaction, the issuing bank 102 may determine that a flexible payment credential 108 was used and then determine which account to debit the funds from, based on the rules established in a rules database 128. The rules database 128 may be a part of a larger system that is hosted, managed, owned, operated, or otherwise provided by the issuing bank 102 to the user 104. The larger system may include an online banking system with mobile applications, web-based applications, or other electronic access to accounts at the issuing bank 102. The user 102 may establish user rules for how certain purchases should be processed. Additionally, the issuing bank 102 may establish bank rules for how various accounts may be used when purchasing goods or services. Also, default rules may be established by the issuing bank 102 or the user 104, where default rules are used when no other rule applies. In an embodiment, the default rule for handling a transaction is to use a prepaid card 118, if possible. In some cases, a prepaid card 118 is not useable because of the type of transaction, amount of transaction, or number of transactions in a period.

Based on the rules, the issuing bank 102 may approve or deny a transaction. If the issuing bank 102 approves the transaction, then the payment network 124 operates to move the money and notify the POS terminal device 120 that the transaction was a success. Alternatively, when the issuing bank 102 denies the transaction, then the payment network 124 operates to cancel the transaction and notify the POS terminal device 120 that the transaction failed.

The issuing bank 102, user device 106, POS terminal device 120, acquiring bank 120, and payment network 124 may be connected via a network 124. The network 126 may include one or more of local-area networks (LAN), wide-area networks (WAN), wireless networks (e.g., 802.11 or cellular network), the Public Switched Telephone Network (PSTN) network, ad hoc networks, cellular, personal area or peer-to-peer networks (e.g., Bluetooth®, Wi-Fi Direct), or other combinations or permutations of network protocols and network types. The network 126 may include a single local area network (LAN) or wide-area network (WAN), or combinations of LANs or WANs, such as the Internet.

Because the payment credential 108 may be used to pay for purchases using various accounts including a prepaid card 118 and a deposit account 110, the user 104 effectively has a debit card to access a deposit account and a prepaid card to access the prepaid card 118. The payment credential 108 may be extended to act as a credit card to access the line of credit 112 or a cash card to access the brokerage 114 or the pre-tax savings account 116.

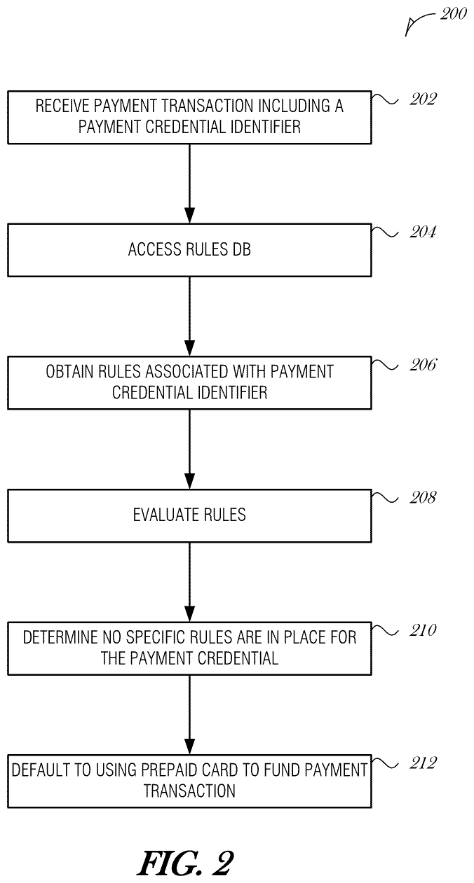

FIG. 2 is a flow diagram illustrating a process 200 for evaluating rules, according to an embodiment. At operation 202, a payment transaction is received from a payment network. The payment transaction may include various aspects of the transaction, such as a payment credential identifier (e.g., credit card number), a merchant name, a merchant category code (MCC), a purchase amount, a date and time of the transaction, etc. At operation 204, a rules database is accessed. At operation 206, rules associated with the payment credential are retrieved. At operation 208, the rules are evaluated. At 210, it is determined that there are no specific rules that apply to the payment transaction for this payment credential. As such, a default rule is applied at 212, where the default rule is to use a prepaid card to fund the transaction.

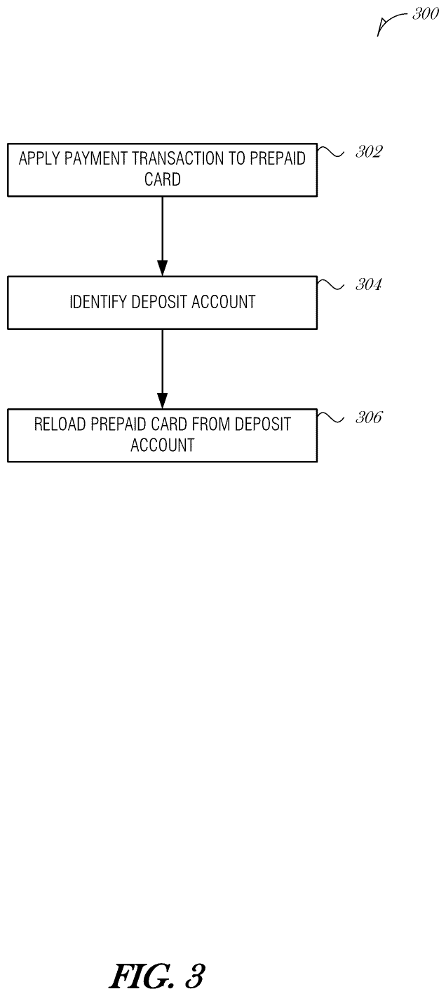

FIG. 3 is a flow diagram illustrating a process 300 for reloading a prepaid card, according to an embodiment. At operation 302, a payment transaction is applied to a prepaid card. The payment transaction includes an associated amount of money used in the transaction. At operation 304, a deposit account is identified. The deposit account may be identified based on rules provided by an account holder of the prepaid card or the deposit account. For instance, using a web-based interface or a mobile app, the account holder is able to configure how much to load onto a prepaid card, trigger events used to initiate the replenishment of its balance, the account from which funds are drawn to load the prepaid card, and the like. Thus, at operation 304, the rules may be accessed and evaluated. At operation 306, the prepaid card is reloaded with a funding amount, which may be the exact amount that was used in the payment transaction, is transferred from the deposit account to the prepaid card. Through use of processes 200 and 300, an issuing bank is able to drive transactions to a prepaid card, which may provide higher interchange fees and thus, higher profit for the issuing bank.

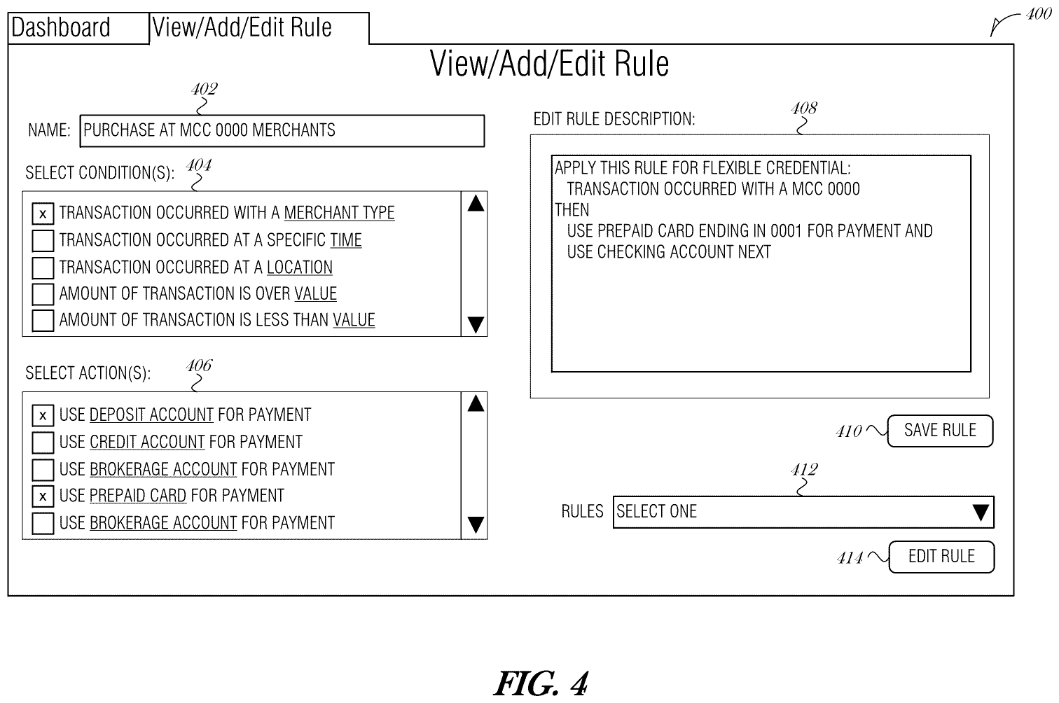

FIG. 4 is an example user interface 400 of an application used to configure rules, according to an embodiment. To add a new rule, a user may provide a name for the rule in a rule name text input control 402. Then the user may select one or more conditions from the conditions control 404. The conditions listed in the conditions selection control 404 are merely examples. More or fewer conditions may be implemented. The user may then select one or more actions from the actions selection control 406.

When a user selects a condition from the conditions selection control 404, the condition is added to the rule description 408. Similarly, when the user selects an action from the actions selection control 406, it is added to the rule description 408. In the rule description 408, the user may further define the condition or the action. In the example illustrated in FIG. 4, the conditions and actions include underlined portions. These underlined portions indicate the configurable portion of the rule. For instance, when the user selects the condition about the “merchant type”, a popup window or other user interface may be provided to the user to select or input the merchant type to use in the condition. Similarly, when the user selects the action to use a deposit account for payment, a user interface may be presented to the user to select from a checking account, a savings account, or another account as the specific account for this action.

Further, in the example illustrated in FIG. 4, the user has selected two actions—one for a prepaid account to be first used to pay for a purchase from merchants with MCC 0000 and then a second fallback deposit account (checking account) to be used if the prepaid account does not have enough to cover the transaction. Once the user has the rule defined, the save button 410 is used to save the rule's settings.

To edit an existing rule, the user may use the select rule dropdown control 412 to select a rule and then when the user presses the edit button 414, the rule and its details are displayed in the name field 402, conditions selection control 404, actions selection control 406, and rule description 408. The user may modify various attributes of the rule and then save it to overwrite the existing rule.

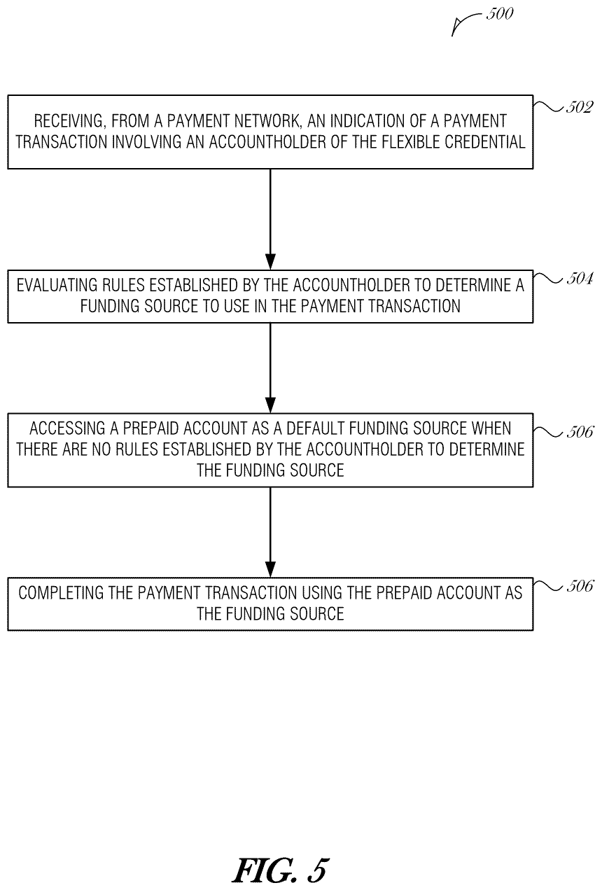

FIG. 5 is a flowchart illustrating a method 500 for processing a transaction for a flexible credential, according to an embodiment. The method 500 may be performed by an electronic system (e.g., issuer bank 102, user device 106, POS terminal device 120, payment network 124) or any of the modules, logic, circuits, processors, or components described herein.

At 502, the method 500 includes the operation of receiving, from a payment network, an indication of a payment transaction involving an accountholder of the flexible credential. In embodiments, the payment network is one of: Visa, Mastercard, or Discover.

In an embodiment, the flexible credential is configured to act as both a debit card to draw from a deposit account and a prepaid card to draw from a prepaid account. In a further embodiment, the flexible credential is configured to draw from a line of credit, a pre-tax savings account, or a brokerage account.

At 504, the method 500 includes the operation of evaluating rules established by the accountholder to determine a funding source to use in the payment transaction.

At 506, the method 500 includes the operation of accessing a prepaid account as a default funding source when there are no rules established by the accountholder to determine the funding source.

At 507, the method 500 includes the operation of completing the payment transaction using the prepaid account as the funding source.

In an embodiment, the payment transaction includes a payment amount. In such an embodiment, the method 500 includes the operation of reloading the prepaid card with a reload amount up to the payment amount.

In an embodiment, the payment transaction includes a payment amount. In such an embodiment, the method 500 includes the operation of reloading the prepaid card with a reload amount equal to the payment amount.

In an embodiment, the payment transaction includes a payment amount. In such an embodiment, the method 500 includes the operation of reloading the prepaid card to a prepaid account limit. For instance, if the prepaid account has a maximum limit of $1000, then after one or more purchases, the prepaid account may be reloaded to the $1000 limit.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

A processor subsystem may be used to execute the instruction on the machine-readable medium. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

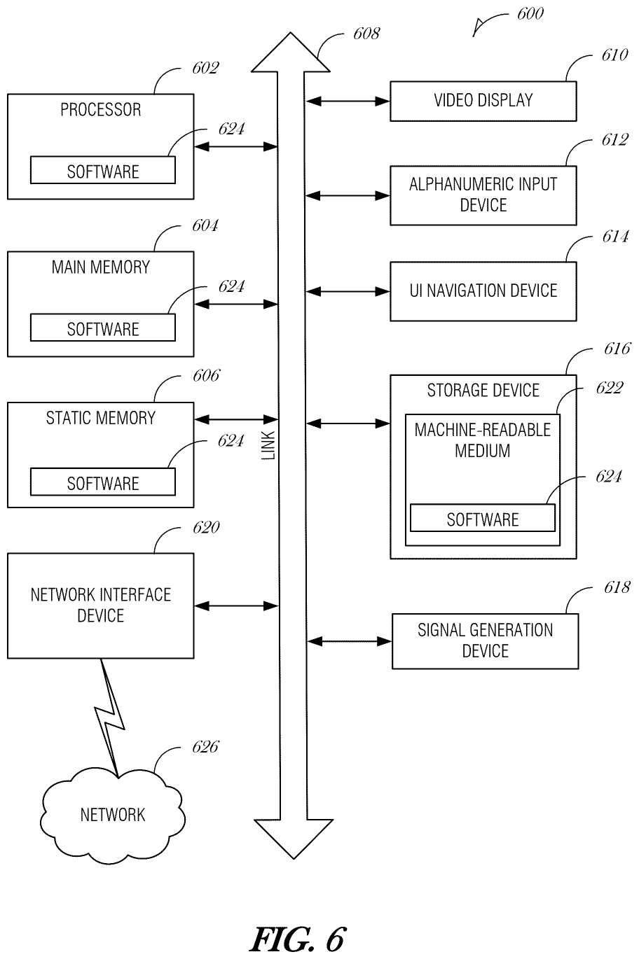

FIG. 6 is a block diagram illustrating a machine in the example form of a computer system 600, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, set-top box, wearable device, personal computer (PC), a tablet PC, a hybrid tablet, a personal digital assistant (PDA), a mobile telephone, cloud server, web server, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 600 includes at least one processor 602 (e.g., a central processing unit (CPU), a graphics processing unit (GPU) or both, processor cores, compute nodes, etc.), a main memory 604 and a static memory 606, which communicate with each other via a link 608 (e.g., bus). The computer system 600 may further include a video display unit 610, an alphanumeric input device 612 (e.g., a keyboard), and a user interface (UI) navigation device 614 (e.g., a mouse). In one embodiment, the video display unit 610, input device 612 and UI navigation device 614 are incorporated into a touch screen display. The computer system 600 may additionally include a storage device 616 (e.g., a drive unit), a signal generation device 618 (e.g., a speaker), a network interface device 620, and one or more sensors (not shown), such as a global positioning system (GPS) sensor, compass, accelerometer, or other sensor.

The storage device 616 includes a machine-readable medium 622 on which is stored one or more sets of data structures and instructions 624 (e.g., software) embodying or utilized by any one or more of the methodologies or functions described herein. The instructions 624 may also reside, completely or at least partially, within the main memory 604, static memory 606, and/or within the processor 602 during execution thereof by the computer system 600, with the main memory 604, static memory 606, and the processor 602 also constituting machine-readable media.

While the machine-readable medium 622 is illustrated in an example embodiment to be a single medium, the term “machine-readable medium” may include a single medium or multiple media (e.g., a centralized or distributed database, and/or associated caches and servers) that store the one or more instructions 624. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

### ADDITIONAL NOTES & EXAMPLES

Example 1 is a system for processing a transaction for a flexible credential, the system comprising: a processor subsystem; and memory including instructions, which when executed by the processor subsystem, cause the processor subsystem to: receive, from a payment network, an indication of a payment transaction involving an accountholder of the flexible credential; evaluate rules established by the accountholder to determine a funding source to use in the payment transaction; access a prepaid account as a default funding source when there are no rules established by the accountholder to determine the funding source; and complete the payment transaction using the prepaid account as the funding source.

In Example 2, the subject matter of Example 1 includes, wherein the payment network is one of: Visa, Mastercard, or Discover.

In Example 3, the subject matter of Examples 1-2 includes, wherein the flexible credential is configured to act as both a debit card to draw from a deposit account and a prepaid card to draw from a prepaid account.

In Example 4, the subject matter of Example 3 includes, wherein the flexible credential is configured to draw from a line of credit, a pre-tax savings account, or a brokerage account.

In Example 5, the subject matter of Examples 3-4 includes, wherein the payment transaction includes a payment amount, and wherein the instructions cause the processor subsystem to reload the prepaid card with a reload amount up to the payment amount.

In Example 6, the subject matter of Examples 3-5 includes, wherein the payment transaction includes a payment amount, and wherein the instructions cause the processor subsystem to reload the prepaid card with a reload amount equal to the payment amount.

In Example 7, the subject matter of Examples 3-6 includes, wherein the payment transaction includes a payment amount, and wherein the instructions cause the processor subsystem to reload the prepaid card to a prepaid account limit.

Example 8 is a method for processing a transaction for a flexible credential, the method performed on an electronic online system, the method comprising: receiving, from a payment network, an indication of a payment transaction involving an accountholder of the flexible credential; evaluating rules established by the accountholder to determine a funding source to use in the payment transaction; accessing a prepaid account as a default funding source when there are no rules established by the accountholder to determine the funding source; and completing the payment transaction using the prepaid account as the funding source.

In Example 9, the subject matter of Example 8 includes, wherein the payment network is one of: Visa, Mastercard, or Discover.

In Example 10, the subject matter of Examples 8-9 includes, wherein the flexible credential is configured to act as both a debit card to draw from a deposit account and a prepaid card to draw from a prepaid account.

In Example 11, the subject matter of Example 10 includes, wherein the flexible credential is configured to draw from a line of credit, a pre-tax savings account, or a brokerage account.

In Example 12, the subject matter of Examples 10-11 includes, wherein the payment transaction includes a payment amount, and wherein the method comprises reloading the prepaid card with a reload amount up to the payment amount.

In Example 13, the subject matter of Examples 10-12 includes, wherein the payment transaction includes a payment amount, and the method comprises reloading the prepaid card with a reload amount equal to the payment amount.

In Example 14, the subject matter of Examples 10-13 includes, wherein the payment transaction includes a payment amount, and the method comprises reloading the prepaid card to a prepaid account limit.

Example 15 is a non-transitory machine-readable medium comprising instructions for processing a transaction for a flexible credential, which when executed by a machine in an online system cause the machine to: receive, from a payment network, an indication of a payment transaction involving an accountholder of the flexible credential; evaluate rules established by the accountholder to determine a funding source to use in the payment transaction; access a prepaid account as a default funding source when there are no rules established by the accountholder to determine the funding source; and complete the payment transaction using the prepaid account as the funding source.

In Example 16, the subject matter of Example 15 includes, wherein the payment network is one of: Visa, Mastercard, or Discover.

In Example 17, the subject matter of Examples 15-16 includes, wherein the flexible credential is configured to act as both a debit card to draw from a deposit account and a prepaid card to draw from a prepaid account.

In Example 18, the subject matter of Example 17 includes, wherein the flexible credential is configured to draw from a line of credit, a pre-tax savings account, or a brokerage account.

In Example 19, the subject matter of Examples 17-18 includes, wherein the payment transaction includes a payment amount, and wherein the instructions cause the machine to reload the prepaid card with a reload amount up to the payment amount.

In Example 20, the subject matter of Examples 17-19 includes, wherein the payment transaction includes a payment amount, and wherein the instructions cause the machine to reload the prepaid card with a reload amount equal to the payment amount.

In Example 21, the subject matter of Examples 17-20 includes, wherein the payment transaction includes a payment amount, and wherein the instructions cause the machine to reload the prepaid card to a prepaid account limit.

Example 22 is at least one machine-readable medium including instructions that, when executed by processing circuitry, cause the processing circuitry to perform operations to implement of any of Examples 1-21.

Example 23 is an apparatus comprising means to implement of any of Examples 1-21.

Example 24 is a system to implement of any of Examples 1-21.

Example 25 is a method to implement of any of Examples 1-21.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. A system for processing a transaction for a flexible credential, the system comprising:
a processor subsystem operated by an issuing bank system; and
memory including instructions, which when executed by the processor subsystem, cause the processor subsystem to:
receive, from a payment network, an indication of a payment transaction involving an accountholder of the flexible credential who is using the flexible credential for payment in the payment transaction, the indication including one or more transaction attributes comprising at least a merchant category code (MCC), a purchase amount, and a date and time of the payment transaction;
access a rules database storing rules associated with the flexible credential;
evaluate rules established by the accountholder to determine a funding source to use in the payment transaction, the rules established by the accountholder with a user device operated by the accountholder, the user device including a financial app to interact with the rules database that stores rules indicating how transactions are handled for the accountholder, and the funding source being one of multiple funding sources and selected by the accountholder, the funding sources including a deposit account, a line of credit, a brokerage account, a pre-tax savings account, and a prepaid account;
access the prepaid account as a default funding source when there are no rules established by the accountholder to determine the funding source or when no evaluated rule applies to the payment transaction;
complete the payment transaction using the prepaid account as the funding source when there are no rules established by the accountholder to determine the funding source by instructing the payment network to settle the transaction using the prepaid account or the funding source determined by the rule evaluation; and
responsive to completing the payment transaction using the prepaid account as the funding source, reload the prepaid account according to a replenishment rule by transferring funds from one or more of the funding sources in an amount up to the purchase amount or to prepaid account limit.

2. The system of claim 1, wherein the payment network is a payment card network.

3. The system of claim 1, wherein the flexible credential is configured to act as both a debit card to draw from a deposit account and a prepaid card to draw from the prepaid account.

4. The system of claim 3, wherein the flexible credential is configured to draw from a line of credit, a pre-tax savings account, or a brokerage account.

5. (canceled)

6. (canceled)

7. (canceled)

8. A method for processing a transaction for a flexible credential, the method performed on an electronic online system operated by an issuing bank, the method comprising:
receiving, from a payment network, an indication of a payment transaction involving an accountholder of the flexible credential who is using the flexible credential for payment in the payment transaction, the indication including one or more transaction attributes comprising at least a merchant category code (MCC), a purchase amount, and a date and time of the payment transaction;
accessing a rules database storing rules associated with the flexible credential;
evaluating rules established by the accountholder to determine a funding source to use in the payment transaction, the rules established by the accountholder with a user device operated by the accountholder, the user device including a financial app to interact with the rules database that stores rules indicating how transactions are handled for the accountholder, and the funding source being one of multiple funding sources and selected by the accountholder, the funding sources including a deposit account, a line of credit, a brokerage account, a pre-tax savings account, and a prepaid account;
accessing the prepaid account as a default funding source when there are no rules established by the accountholder to determine the funding source or when no evaluated rule applies to the payment transaction;
completing the payment transaction using the prepaid account as the funding source when there are no rules established by the accountholder to determine the funding source by instructing the payment network to settle the transaction using the prepaid account or the funding source determined by the rule evaluation; and
responsive to completing the payment transaction using the prepaid account as the funding source, reloading the prepaid account according to a replenishment rule by transferring funds from one or more of the funding sources in an amount up to the purchase amount or to a prepaid account limit.

9. The method of claim 8, wherein the payment network is a payment card network.

10. The method of claim 8, wherein the flexible credential is configured to act as both a debit card to draw from a deposit account and a prepaid card to draw from the prepaid account.

11. The method of claim 10, wherein the flexible credential is configured to draw from a line of credit, a pre-tax savings account, or a brokerage account.

12. (canceled)

13. (canceled)

14. (canceled)

15. A non-transitory machine-readable medium comprising instructions for processing a transaction for a flexible credential, which when executed by a machine in an online system operated by an issuing bank, cause the machine to:
receive, from a payment network, an indication of a payment transaction involving an accountholder of the flexible credential who is using the flexible credential for payment in the payment transaction. the indication including one or more transaction attributes comprising at least a merchant category code (MCC), a purchase amount, and a date and time of the payment transaction;
access a rules database storing rules associated with the flexible credential;
evaluate rules established by the accountholder to determine a funding source to use in the payment transaction, the rules established by the accountholder with a user device operated by the accountholder, the user device including a financial app to interact with the rules database that stores rules indicating how transactions are handled for the accountholder, and the funding source being one of multiple funding sources and selected by the accountholder, the funding sources including a deposit account, a line of credit, a brokerage account, a pre-tax savings account, and a prepaid account;
access the prepaid account as a default funding source when there are no rules established by the accountholder to determine the funding source or when no evaluated rule applies to the payment transaction;
complete the payment transaction using the prepaid account as the funding source when there are no rules established by the accountholder to determine the funding source by instructing the payment network to settle the transaction using the prepaid account or the funding source determined by the rule evaluation; and
responsive to completing the payment transaction using the prepaid account as the funding source, reload the prepaid account according to a replenishment rule by transferring funds from one or more of the funding sources in an amount up to the purchase amount or to a prepaid account limit.

16. The non-transitory machine-readable medium of claim 15, wherein the payment network is a payment card network.

17. The non-transitory machine-readable medium of claim 15, wherein the flexible credential is configured to act as both a debit card to draw from a deposit account and a prepaid card to draw from the prepaid account.

18. The non-transitory machine-readable medium of claim 17, wherein the flexible credential is configured to draw from a line of credit, a pre-tax savings account, or a brokerage account.

19. (canceled)

20. (canceled)
